(19) United States
(12) Patent Application Publication
(10) Pub. No.: US 2003/0170068 A1
(43) Pub. Date: Sep. 11, 2003

(54) Method and apparatus for packaging ring mechanisms for a binder

(76) Inventor: Donald Grant Smith, Mundelein, IL (US)

Correspondence Address: MICHAEL BEST & FRIEDRICH, LLP, 100 E WISCONSIN AVENUE, MILWAUKEE, WI, 53202, US

(21) Appl. No.: 10/379,286

(22) Filed: Mar. 3, 2003

Related U.S. Application Data
(60) Provisional application No. 60/362,111, filed on Mar. 6, 2002.

(51) Int. Cl. B42F 3/00

(52) U.S. Cl. 402/70

(57) ABSTRACT

A method of arranging ring mechanisms having a base, and a ring movable to an open position. The method comprises opening the ring of a first ring mechanism and placing the base of a second ring mechanism at least partially within the open ring of the first ring mechanism.

### RELATED APPLICATION DATA

The present application claims the benefit of co-pending U.S. provisional patent application Serial No. 60/362,111, filed Mar. 6, 2002.

### BACKGROUND OF THE INVENTION

The present invention generally relates to ring binders such as three-ring binders for holding loose-leaf paper. More specifically, the present invention relates to methods of manufacturing, packaging, and shipping ring mechanisms that are used to make ring binders.

FIG. 1 illustrates a prior method of shipping ring mechanisms commonly used in the manufacture of binders. The ring mechanisms are closed and then stacked in a box for shipment to the assembly plant or area where they are mated with a binder cover to form a completed binder. The ring mechanisms are placed side-by-side such that the bases of adjacent ring mechanisms contact one another. In some cases, this allows for a slight overlap of the rings, thereby requiring a small offset to facilitate close packing. A piece of cardboard or other spacer is placed on top of the completed row to provide a flat surface for the next row. Using this process, several rows are stacked on top of one another within the box.

In the closed position, the ring mechanisms cannot be interlocked efficiently. This results in a large amount of empty space within the box. The empty space within the box not only increases the shipping and handling costs but also requires additional space for storage, packing, and unpacking. In addition, the current method of shipment makes it difficult to automate the process of moving the ring mechanisms from the box to the assembly line. At present, a manual operation requires an operator to individually place each ring mechanism on the assembly line.

A method of shipping ring mechanisms for binders that both reduces the shipping volume per unit shipped and simplifies the process of moving the ring mechanisms from the shipping container to the binder assembly line would be welcome in the binder manufacturing industry.

### SUMMARY OF THE PREFERRED EMBODIMENT

The present invention provides a method for efficiently shipping ring mechanisms. Each of the ring mechanisms includes a base and a ring movable to an open position. The method comprises opening the ring of a first ring mechanism and placing a second ring mechanism at least partially within the open ring of the binder ring mechanism. Preferably, a carrier engages the first ring mechanism and the second ring mechanism to hold the ring mechanisms in the desired position. In addition, the method can include placing a plurality of additional ring mechanisms at least partially within the open rings of the second ring mechanism and each successive ring mechanism of the plurality of additional ring mechanisms to produce a stack.

Additional features and advantages will become apparent to those skilled in the art upon consideration of the following detailed description exemplifying the best mode of carrying out the invention as presently perceived.

### BRIEF DESCRIPTION OF THE DRAWINGS

The detailed description particularly refers to the accompanying figures in which:

FIG. 1 is an end view of the prior art method of shipment;

FIG. 2 is an end view of a shipping box filled with stacks of ring mechanisms consistent with the present invention;

FIG. 3 is a perspective view of a partial stack of ring mechanisms consistent with the present invention;

FIG. 4 is a side view of the partial stack of FIG. 3;

FIG. 5 is a side view of an alternative embodiment of the present invention using a wire carrier to hold the ring mechanisms in a stack;

FIG. 6 is an end view of the wire carrier of FIG. 5; and

FIG. 7 is a perspective view of a binder including a cover and a ring metal.

### DETAILED DESCRIPTION OF THE DRAWINGS

The system and method described herein allow for both convenient and efficient shipment and storage of ring mechanisms 5 (illustrated best in FIG. 3) commonly used in the manufacture of binders. Binders generally have two major components, a binder cover 6 (shown in FIG. 7) comprising a front cover 7, a back cover 8, a spine 9 connecting the front and back covers 7, 8, and the ring mechanism 5, sometimes referred to as a metal, comprised of rings 10 and a base 15. The rings 10 attach to the base 15 and can be opened for the receipt of paper and closed to retain paper therein. The base 15 of the ring mechanism 5 engages the binder cover 6 to complete the binder. It is common practice to manufacture the two components at separate facilities or separate areas of a plant. This practice requires the shipment of one or more of the components to an assembly location. Upon receipt of the ring mechanisms 5, they must be placed on a conveyor of an assembly line to facilitate the final assembly process.

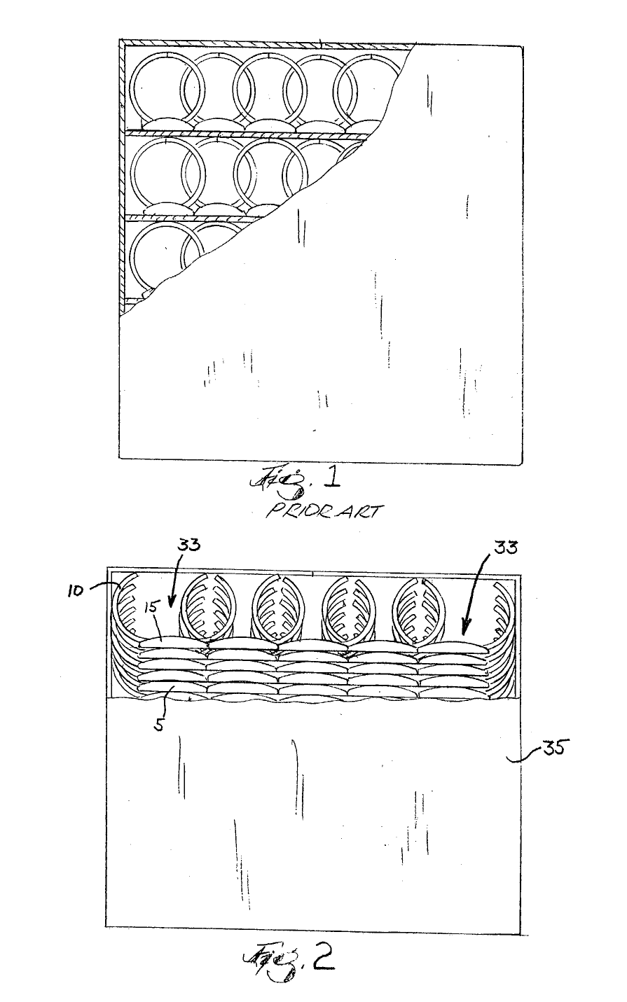

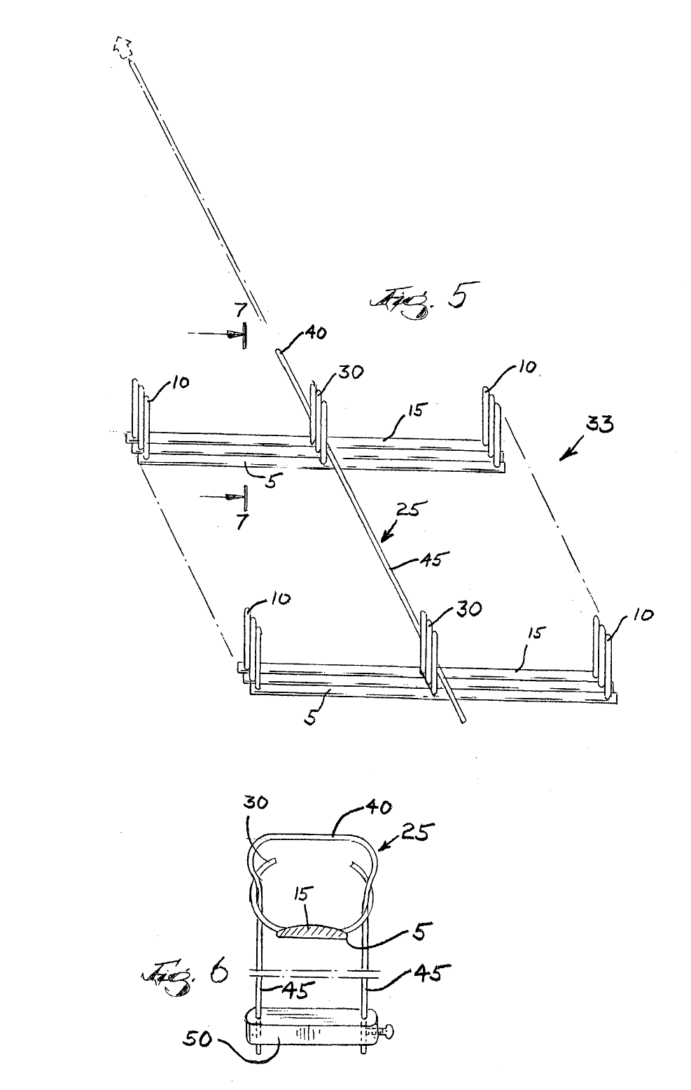

FIGS. 3 and 4 illustrate a partial stack 7 of ring mechanisms 5 prepared for shipment according to the method of the present invention. Rather than shipping the ring mechanisms 5 closed as shown in FIG. 1, the ring mechanisms 5 are opened to facilitate more efficient stacking. A carrier, such as a wire carrier 25 (shown in FIG. 5) engages the ring mechanisms 5 to retain them in the open stacked configuration during shipment and distribution onto the assembly line conveyor.

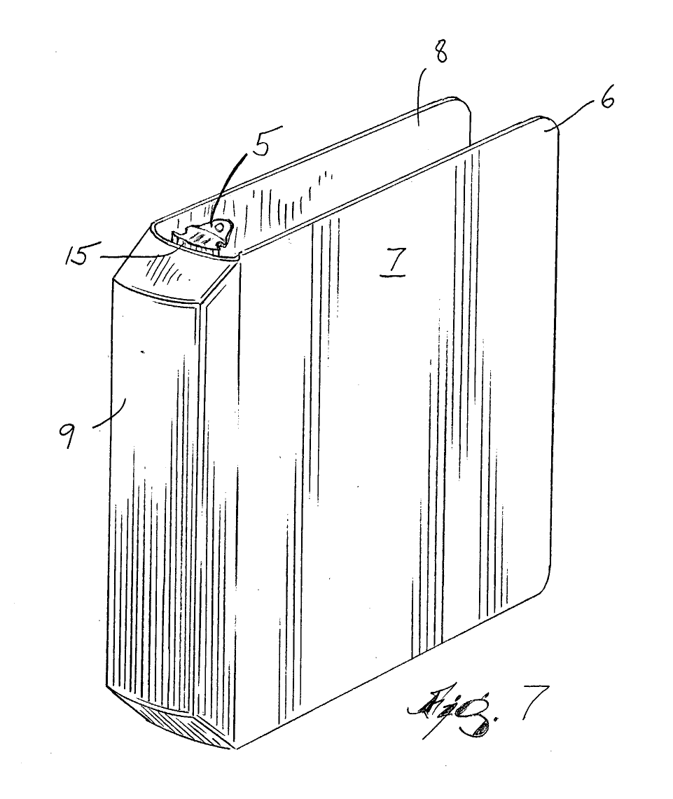

In the embodiment of FIGS. 5 and 6, the wire carrier 25 engages the center ring 30 of a three-ring binder. It should be understood that the wire carrier 25 could instead engage one of the outer rings 10 rather than the center ring 30.

While three-ring ring mechanisms 5 are illustrated, the invention is well suited to ring mechanisms having more or less than three rings 10. Some of these embodiments require the wire carrier 25 to engage a ring 10 other than the center ring 30. For example, a four-ring binder has no center ring 30, As such, the wire carrier 25 must engage one of the rings 10 offset from the center of the binder.

The embodiment of FIGS. 5 and 6 employs a single wire carrier 25. Generally, one wire carrier 25 provides sufficient strength and stability to support a stack 33. However, it is contemplated that larger stacks or larger ring mechanisms 5 may require additional wire carriers 25 to provide the necessary support. Therefore, other embodiments of the invention use two or more wire carriers 25 per stack 33 to provide the desired support and restraint.

To assemble a stack 33, an operator or machine opens the first ring mechanism 5 and places it on the wire carrier 25. The next ring mechanism 5 is then opened and placed on the wire carrier 25. Because the rings 10 of the first and second ring mechanisms 5 are open, the base 15 of one of the ring mechanisms 5 is free to pass through the open rings 10 and rest on, or very near, the base 15 of the other ring mechanism 5. For example, FIG. 6 illustrates the first ring mechanism 5 positioned on the wire carrier 25. The nest ring mechanism 5 would slide onto the wire carrier 25 such that the open rings 10 pass the base 15 of the first ring mechanism 5 until the base 15 of the second ring mechanism 5 abuts, or very nearly abuts, the base 15 of the first ring mechanism 5. In another construction, the first ring mechanism 5 is oriented in an inverted position when compared to the condition illustrated in FIG. 6. In this orientation, the base 15 of the second ring mechanism 5 passes through the open rings 10 of the first binder ring mechanism 5 until the base 15 of the second ring mechanism abuts, or very nearly abuts, the base of the first binder ring mechanism.

No matter the assembly technique used, the rings 10 of the second ring mechanism 5 are offset to one side of the rings 10 of the first ring mechanism 5 to provide a snug fit. The offset allows subsequent rings 10 to stack next to their predecessors to improve the compactness of the stack 33. Additional ring mechanisms 5 are stacked in the same manner, each ring mechanism 5 passing over the wire carrier 25 and into position above the last. As more ring mechanisms 5 are added, the continued offset results in the stack 33 skewing in the direction of the offset, as is best shown in FIG. 5.

In yet another embodiment of the assembly method, the operator first stacks the ring mechanisms 5 and then inserts the wire carrier 25 into the completed stack 33. In still other embodiments, no wire carrier is used. Instead, the stack is placed in a shipping container, which acts to support and maintain the ring mechanisms in the stack. In still another construction, an external carrier such as tape or string maintains the ring mechanisms in the stack.

While a skewed stack 33 is shown in FIG. 5, other embodiments and other ring mechanisms 5 allow the offset to be alternated to prevent any substantial skew from arising. For example, the first five ring mechanisms 5 of a stack could be offset to the left, as illustrated in FIG. 5, while the next five ring mechanisms 5 are offset to the right. This arrangement reduces the total skew of the stack 33.

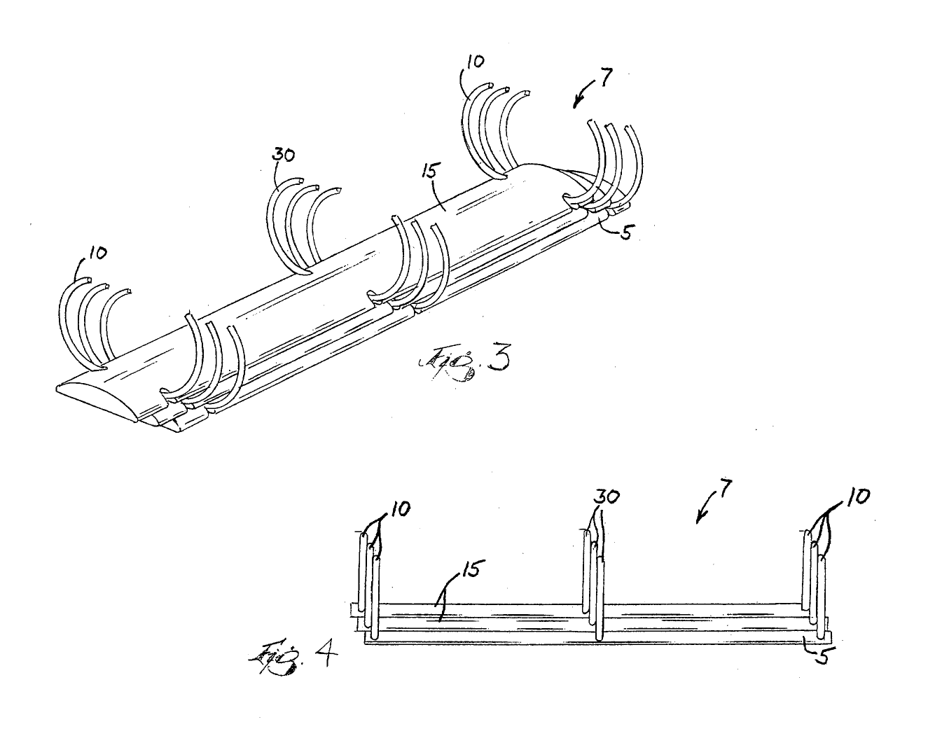

Stacks 33 prepared as just described can be placed in a box 35 for shipment as shown in FIG. 2. The compact arrangement achieved by following the method described herein allows for a significant increase in the quantity of ring mechanisms 5 shipped per box 35. However, it is preferable to ship ring metal stacks prepared as just described without the use of any box 35. The elimination of the box 35 produces both cost and labor savings in the shipping process. When shipping without a box, the stacks 33 are placed onto a shipping container such as a pallet. The stacks 33 are stacked to a height and then wrapped with plastic, tape, or other material to band the stacks 33 to the pallet. This method eliminates not only the cardboard boxes required when using prior art shipping methods, but also eliminates the labor required to pack and unpack the boxes.

FIGS. 5 and 6 better illustrate the wire carrier 25 and its use. The wire carrier 25 includes a handle end 40, two prongs 45, and in some cases a closure member 50. The handle end 40 provides a convenient handle for inserting or removing the wire carrier 25 from the stack 33. In addition, the handle end 40 supports the two prongs 45 at a desired distance from one another. The two prongs 45 extend the full length of the stack 33 and are spaced a parallel distance from one another. The distance between the prongs 45 depends on the size of the rings 10 of the ring mechanisms 5. The prongs 45, when inserted into the rings 10, hold the rings 10 open by being spaced apart a distance approximately equal to the largest inside diameter of the open rings 10.

In some embodiments, the closure member 50, shown in FIG. 6, fits over the open end of the prongs 45 to maintain the proper spacing between the prongs 45 and/or to inhibit the accidental removal of the wire carrier 25. The closure member 50 can be as simple as a large nut, and as complex as a clamp sized to separate and engage both prongs 45.

To begin binder assembly, an operator places an assembled stack 33 of ring mechanisms 5 into a separator device and removes the wire carrier 25. After use, the wire carrier 25 is either discarded or reused. The separator device places individual ring mechanisms 5 on the conveyor at the start of the assembly process, thus eliminating the need for manual placement of each ring mechanism 5. Instead, the operator places stacks 33 containing large quantities of ring mechanisms 5 into the separator device for eventual distribution to the conveyor.

Manual methods of unstacking the stack 33 of ring mechanisms are also possible using the present invention. In a manual method, an operator performs the functions of the separator machine previously described. The operator grasps the stack 33 of ring mechanisms 5 in one hand and the handle end 40 of the wire carrier 25 in the other. The operator removes the wire carrier 25 from the stack 33. Once the wire carrier 25 disengages a ring mechanism 5, the ring mechanism 5 is free to fall to the conveyor. Rather than moving several ring members 5 packed as shown in FIG. 1 to the assembly line, the operator grabs a stack 33 having a large quantity of ring mechanisms 5. This reduces the number of trips made by the operator between the unpacking area and the assembly line, thus improving the operator's efficiency. For example, an operator could easily carry two stacks 33, each stack having twenty or more ring mechanisms 5. The only limits to the number of ring mechanisms 5 contained within a stack 33 are the size and weight of the shipping container containing the ring mechanisms 5 and the capacity of the separator. Some embodiments use ring mechanism stacks 33 of fifty ring mechanisms 5, while still other embodiments employ stacks 33 having one hundred ring mechanisms 5 or more.

Although the invention has been described in detail with reference to certain preferred embodiments, variations and modifications exist within the scope and spirit of the invention as described and defined in the following claims.

What is claimed is:

1. A method of arranging ring mechanisms having a base and a ring movable to an open position, the method comprising:
opening the ring of a first ring mechanism; and
placing a second ring mechanism base at least partially within the open ring of the first ring mechanism.

2. The method of claim 1, further comprising engaging a carrier with the first ring mechanism and the second ring mechanism.

3. The method of claim 2, further comprising connecting a closure member to the carrier to inhibit the disengagement of the carrier from the first and second ring mechanisms.

4. The method of claim 3, wherein the closure member threads to the carrier.

5. The method of claim 2, wherein the carrier is positioned to engage the ring of the first ring mechanism and the ring of the second ring mechanism.

6. The method of claim 1, wherein placing the second ring mechanism base includes offsetting the ring of the first ring mechanism relative to the ring of the second ring mechanism.

7. The method of claim 1, further comprising:
opening a ring of a plurality of additional ring mechanisms;
placing a first of the plurality of additional ring mechanisms at least partially within the ring of the second ring mechanism; and
placing each successive ring mechanism of the plurality of additional ring mechanisms at least partially within the previous ring mechanism.

8. A ring mechanism stack comprising:
a first ring mechanism including a base and a ring in an open position; and
a second ring mechanism including a base and a ring, the second ring mechanism base positioned at least partially within the open ring of the first ring mechanism.

9. The ring mechanism stack of claim 8, further comprising a carrier engagable with the first ring mechanism and the second ring mechanism.

10. The ring mechanism stack of claim 9, further comprising a closure member connected to the carrier to inhibit disengagement of the carrier from the first ring mechanism and the second ring mechanism.

11. The ring mechanism stack of claim 10, wherein the closure member is threaded to the wire carrier.

12. The ring mechanism stack of claim 9, wherein the carrier engages the ring of the first binder ring mechanism and the ring of the second binder ring mechanism.

13. The ring mechanism stack of claim 8, wherein the first ring mechanism and the second ring mechanism each include at least three rings.

14. The ring mechanism stack of claim 8, wherein the ring of the second ring mechanism is offset relative to the ring of the first ring mechanism when the second ring mechanism base is positioned at least partially within the first ring mechanism.

15. The ring mechanism stack of claim 8, further comprising a plurality of additional ring mechanisms, the first of the plurality of additional ring mechanisms at least partially within the ring of the second ring mechanism and each successive ring mechanism of the plurality of additional ring mechanisms at least partially disposed within the previous ring mechanism.

16. The ring mechanism stack of claim 15, further comprising a carrier that engages the first ring mechanism, the second ring mechanism, and each of the plurality of additional ring mechanisms.

17. A method of shipping a plurality of binder ring mechanisms, each ring mechanism including a base and a ring movable between an open position and a closed position, the method comprising:
orienting a first ring mechanism with the ring in the open position;
orienting a second ring mechanism with the ring in the open position;
placing the base of the second ring mechanism at least partially within the open ring of the first ring mechanism; and
sequentially orienting and placing the base of each of the remainder of the plurality of ring mechanisms within the open rings of the previous ring mechanism to define a stack of ring mechanisms.

18. The method of claim 17, further comprising engaging a carrier with the stack of ring mechanisms.

19. The method of claim 18, further comprising connecting a closure member to the carrier to inhibit disengagement of the carrier from the stack.

20. The method of claim 19, further comprising turning a threaded member to connect the closure member to the carrier.

21. The method of claim 18, wherein the carrier engages the ring of the first ring mechanism and the ring of the second ring mechanism.

22. The method of claim 17, wherein the ring of the second ring mechanism is offset from the ring of the first ring mechanism.

23. The method of claim 17, wherein the ring of each of the plurality of ring mechanisms is offset relative to the rings of the remaining plurality of ring mechanisms.

24. The method of claim 17, further comprising placing the stack of ring mechanisms onto a shipping container.
